(19) United States
(12) Patent Application Publication
(10) Pub. No.: US 2026/0212856 A1
(43) Pub. Date: Jul. 23, 2026

(54) REDUCING RESPONSE TIMES IN CONVERSATIONAL AI SYSTEMS AND APPLICATIONS

(71) Applicant: NVIDIA Corporation, Santa Clara, CA (US)

(72) Inventor: Karl Alexander Koscher, Seattle, WA (US)

(21) Appl. No.: 19/034,033

(22) Filed: Jan. 22, 2025

(51) Int. Cl. G10L 13/027; G10L 15/183

(52) U.S. Cl. CPC G10L 13/027; G10L 15/183

(57) ABSTRACT

In various examples, response times (e.g., latencies) associated with conversational artificial intelligence (AI) systems may be reduced by sharing partial results between modules or components of the conversational AI systems. For example, instead of waiting for an automatic speech recognition (ASR) system to finish converting a user utterance into text data, the systems of the present disclosure may obtain candidate prefixes for the utterance from the ASR system and use a language model to predict the complete utterance based on the candidate prefixes, as well as to generate responses to the predicted utterances. As additional information is obtained (e.g., remaining portions of the utterance), the language model may update the predicted utterance and/or the response. Additionally, in some instances the systems of the present disclosure may begin forwarding the response to a Text-To-Speech (TTS) system before the language model finishes generating the response.

### BACKGROUND

Conversational artificial intelligence (AI) systems often use a plurality of discrete modules or components to process and respond to user utterances. For example, in many existing implementations, the conversational AI system may first run an Automated Speech Recognition (ASR) algorithm to transcribe the user's spoken input into text. Once the transcription is complete, it may be forwarded to a Language Model (LM)—such as a Large Language Model (LLM), Vision Language Model (VLM), or the like—which may generate an appropriate response based on the context of the conversation. The output from the LM may then be converted into speech (e.g., a voice response) using a Text-To-Speech (TTS) system. In conventional systems, the stages of this pipeline are typically independent from one another, with little to no overlap or concurrency between stages.

However, conventional conversational AI systems often suffer from delays between the user's input and the system's response. For instance, the sequential nature of conversational AI pipelines prevents real-time adaptation or early response generation, limiting the ability of conversational AI systems to appear conversationally natural. As such, despite advancements in natural language processing and speech synthesis, the latencies commonly associated with conventional conversational AI systems may disrupt the flow of interaction, creating an unnatural and sometimes frustrating experience for users.

### SUMMARY

Embodiments of the present disclosure relate to reducing response times in conversational artificial intelligence (AI) systems and applications. Systems and methods are disclosed that share partial results between different systems, modules, or components of a conversational AI system to decrease response times (e.g., latencies) between user prompts and AI-generated responses. For example, instead of waiting for an automatic speech recognition (ASR) system to finish converting a user utterance into text data, the systems of the present disclosure may obtain candidate prefixes for the utterance from the ASR system and use a language model to predict one or more potential complete utterances for each candidate prefixes, as well as to generate a response to each of the predicted utterances. As additional information is obtained (e.g., remaining portions of the utterance), the language model may update the predicted utterance and/or the response. Additionally, in some instances, the systems of the present disclosure may begin forwarding the response to a Text-To-Speech (TTS) system before the language model finishes generating the response.

In contrast to conventional systems, the systems of the present disclosure, in some embodiments, are able to reduce the amount of time (latency) between spoken user prompts and responses to the user prompts by at least partially overlapping operations of the different systems, modules, and/or components of a conversational AI system. For instance, by forwarding candidate utterance prefixes to a language model prior to an ASR system completing audio to text conversion, the systems of the present disclosure exploit the ability of language models to complete text - including prompts from a user—as well as the ability to inject randomness to explore different possible completions of a prompt. As such, the systems of the present disclosure may be able to more effectively predict different user queries and preemptively begin to answer them without having to rely on other systems (e.g., ASR systems) to fully complete their operations. In this way, the systems of the present disclosure may be able to respond to user utterances in shorter amounts of time than conventional systems, thereby maintaining the flow of interaction and creating a more natural conversational experience for the user.

### BRIEF DESCRIPTION OF THE DRAWINGS

The present systems and methods for reducing response times in conversational artificial intelligence (AI) systems and applications are described in detail below with reference to the attached drawing figures, wherein:

FIG. 1 is a data flow diagram illustrating an example of a process that may be performed by a conversational AI system to generate a response to a user utterance, in accordance with some embodiments of the present disclosure;

FIG. 2 illustrates example detail associated with the text data of the example of FIG. 1, in accordance with some embodiments of the present disclosure;

FIG. 3 is a data flow diagram illustrating an example of a process that may be performed by a recognition model(s) to generate a candidate word sequence from input audio data, in accordance with some embodiments of the present disclosure;

FIG. 4 illustrates an example of using one or more language model(s) of a conversational AI system to generate a plurality of predicted utterances and candidate responses based on candidate word sequences, in accordance with some embodiments of the present disclosure;

FIG. 5 is a data flow diagram illustrating an example of selecting a candidate response, in accordance with some embodiments of the present disclosure;

FIG. 6 illustrates an example of using a conversion model to precompute output data, in accordance with some embodiments of the present disclosure;

FIG. 7 illustrates an example of a system that may perform one or more of the processes described herein, in accordance with some embodiments of the present disclosure;

FIG. 8 is a flow diagram illustrating an example of a method for reducing response times in conversational AI systems, in accordance with some embodiments of the present disclosure;

FIG. 9 is a flow diagram illustrating an example of a method for precomputing responses to predicted user utterances to reduce conversational AI system latencies, in accordance with some embodiments of the present disclosure;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11 is a block diagram of an example computing device suitable for use in implementing at least some embodiments of the present disclosure; and

FIG. 12 is a block diagram of an example data center suitable for use in implementing at least some embodiments of the present disclosure.

### DETAILED DESCRIPTION

Systems and methods are disclosed related to reducing response time in conversational artificial intelligence (AI) systems and applications. For instance, a system(s) may apply, as input to a language model (e.g., one or more language models, LLMs, VLMs, MMLMs, etc.) of a conversational AI system, a plurality of predicted prefixes of a user utterance (and/or other input type, such as image, video, sensor data, audio, text, 3D design data, universal scene descriptor (USD) data, etc.). As described herein, in various instances the predicted prefixes may be applied to the language model prior to the system(s) obtaining a remainder of the user utterance and/or the complete user utterance. In some examples, the system(s) may use the language model to generate a plurality of predicted user utterances (e.g., candidate utterances, where one of the candidates may correspond to the actual user utterance). Additionally, the system(s) may use the language model (or another language model) to generate a plurality of candidate responses to the plurality of predicted user utterances. In some examples, the system(s) may determine (e.g., after obtaining additional information related to the user utterance) that the actual user utterance corresponds to a specific one of the predicted user utterances. The system(s) may then use one of the candidate responses that corresponds to the specific predicted user utterance to generate output audio data representative of the response.

In some examples, the system(s) may generate, obtain, receive, determine, and/or retrieve audio data representing speech from a user. As described herein, the speech may be associated with the user utterance. For example, the speech may be associated an utterance such as “what is the capital of Idaho and why was it chosen for the capital?”. The system(s) may process the audio data using one or more techniques to generate text data associated with the speech. For instance, in some examples, the system(s) may process the audio data using an automatic speech recognition (ASR) system, component, or module to generate the text data. As such, in some examples, the text data may be associated with a text transcript of the speech, such as by representing the words, style, punctuation, and/or the like that matches the speech. Additionally, in some examples, the text may be represented using one or more tokens, such as one or more tokens that represent portions of words, words, punctuation, symbols, letters, and/or so forth from the text.

However, as described herein, instead of waiting for the ASR system to finish generating the text data representing the entire user utterance, in some instances the system(s) may obtain, from the ASR system, text data (also referred to herein as “first text data”) representing the plurality of predicted prefixes of the user utterance. In some examples, the ASR system may generate the plurality of predicted prefixes as part of processing the audio data corresponding to the user utterance and determining the actual words or sequence of words included in the speech. As such, and as described in further detail herein, the predicted prefixes may be different from one another as the models of the ASR system continue to process more and more of the audio data and make predictions about what the user said based on context, phonemes included in the utterance, etc. As an example, for the utterance of “what is the capital of Idaho and why was it chosen for the capital?”, after the ASR system finishes processing the audio data corresponding to “what is the capital”, the plurality of predicted prefixes of the utterance may include, for instance, “what is the capital”, “what's the capital”, “what is a capital”, “what is a Capitol”, “what is a cap at all”, what is the cap it'll”, and/or other variations. In some examples, the predicted prefixes may correspond to, for instance, multiple “SpeechRecognitionAlternatives” associated with a “SpeechRecognitionResult,” as described in the Web Speech API.

In some examples, the system(s) may apply the plurality of predicted prefixes (e.g., the first text data representing the predicted prefixes) as input prompts to one or more language models (e.g., one or more large language models (LLM) or any other type of language model). For instance, the system(s) may apply the plurality of predicted prefixes as the input prompts to the language model(s) prior to obtaining one or more remainders of the utterance prefixes and/or the complete utterance (e.g., second text data representing updated versions of the prefixes and/or the remainder of the utterance). As an example, the system(s) may apply the plurality of predicted prefixes to the language model(s) and, in the input prompt(s), instruct the language model(s) to complete the utterance and generate responses to the utterance.

In some examples, based at least on applying the plurality of predicted prefixes of the utterance as part of the input prompt(s) to the language model(s), the language model(s) may process the input prompt(s) (e.g., the first text data and/or first tokens representing the first text data) and generate a plurality of predicted versions of the utterance and a plurality of candidate responses to the predicted versions of the utterance. For instance, the plurality of predicted prefixes may be fed into the language model as a single batch, amortizing the computing cost across multiple potential utterances. Additionally, when the “temperature” of the language model(s) is non-zero, each predicted prefix may be duplicated in the same batch, but resulting in slightly different ways of completing each candidate. As an example, for a first predicted prefix of “what is the capital”, the prefix may be duplicated and the language model(s) may complete the prefix multiple times as “what is the capital of the world?”, “what is the capital of the United States?”, “what is the capital of Idaho?”, and so forth. Additionally, for a second predicted prefix of “what is a capital”, the prefix may be duplicated and the language model(s) may complete the prefix multiple times as “what is a capital letter?”, “what is a capital offense?”, “what is a capital gain?”, and so forth.

Additionally, the language model(s) may generate a plurality of candidate responses to the predicted version of the utterance. Continuing the above examples, candidate responses may be generated for each of the predicted utterances. As an example, for the predicted utterance of “what is the capitol building” the language model(s) may generate a candidate response of “the Capitol building is where the United States Congress meets in Washington, D.C., and it houses the Senate and the House of Representatives”, for the predicted utterance of “what is the capital of the United States” the language model(s) may generate a candidate response of “the capital of the United States is Washington, D.C.”, for the predicted prefix of “what is the capital of Idaho” the language model(s) may generate a candidate response of “the capital of Idaho is Boise”, for the predicted prefix of “what is a capital” the language model(s) may generate a candidate response of “a capital is a city where a government's central offices and leaders are located”, and so forth. In some examples, the language model(s) may generate a plurality of tokens representing text data corresponding to the plurality of candidate responses.

In some examples, the system(s) may use a single language model to generate the predicted versions of the utterance and the candidate responses. In such instances, the system(s) may update one or more parameters of the language model to adjust the temperature of the model between the generation of the predicted utterances and the generation of the candidate responses. That is, the language model's temperature may be adjusted after an “end of prompt” token (or similar) to reduce the amount of randomness in generated responses to the prompt. Additionally, or alternatively, the language model may be halted at the end of prompt token to avoid over-computing potential responses, especially when the initial query from the user has a lot of uncertainty. In some examples, instead of using a single language model, the system(s) may use a first language model to generate the predicted versions of the utterance and a second language model to generate the candidate responses to the predicted versions of the utterances. The first language model may be associated with a first temperature such that the first language model generates more diverse and/or creative predicted utterances, while the second language model may be associated with a second temperature such that the second language model reduces the amount of randomness in generated responses to the predicted utterances.

In some instances, the system(s) may obtain additional information from the ASR system (e.g., the second text data or a portion of the second text data representing at least a portion of the remainder of the utterance) and use it to update the language models, its outputs, confidence scores, etc. For example, as the models of the ASR system continue to process the input audio data, the models may, at some point, determine with relatively high confidence that the prefix of the utterance “what is the capital of Idaho and why was it chosen for the capital?” includes the text “what is the capital of Idaho and why . . . ”. Although the ASR system may still continue to further process the audio data to eventually determine the complete user utterance, this updated prefix may be forwarded to the language model(s). The language model(s) may then use this updated prefix to adjust its own predictions and outputs. For instance, a key-value (KV) cache of the prefill/decode steps of each predicted utterance candidate and corresponding response may be saved, and when the ASR model further narrows down candidates and/or produces additional words, the language model(s) may retrieve prefix-matched KV cache entries to continue prefill/decode steps without recomputing over previously-seen tokens. In other words, the language models may use the updated prefixes from the ASR system to fetch those KV cache entries that include the text of “what is the capital of Idaho and why” and continue further processing to predict the utterance with these candidates. For instance, the language model(s) may generate predicted utterances that recite “what is the capital of Idaho and why is Idaho famous for potatoes?”, “what is the capital of Idaho and why is Idaho called the gem state?”, “what is the capital of Idaho and why is the weather there constantly changing?”, and so forth. Additionally, the language model(s) may generate candidate responses bases on these predicted utterances, as described herein.

In various examples, one of the candidate predicted utterances determined using the language models may actually correspond to the true spoken utterance of the user. For instance, the language model(s) may predict the utterance to be “what is the capital of Idaho and why was it chosen for the capital?” or some similar variation, such as “what is the capital of Idaho and why?”, “what is the capital of Idaho and why is it the capital?”, and/or so forth. Additionally, in some examples, the total number of candidate predicted utterances and/or candidate responses may vary dynamically based on the amount of free compute available. For example, during off-peak hours, if the language model(s) uses fixed batch sizes, the system(s) may allocate more batch entries to each user, giving the system(s) more possible utterances and/or responses to explore. In such scenarios, because the batch size is fixed, this increased computation may be essentially “free”.

In some instances, the system(s) may determine that a first predicted version of the utterance (e.g., from the plurality of predicted versions of the utterance) corresponds to the actual version of the utterance. For instance, the system(s) may obtain the actual version of the utterance (e.g., the second text data representing the actual version of the utterance) from the ASR system and compare it with the plurality of predicted versions of the utterance to determine which predicted utterance of the plurality of predicted versions of the utterance corresponds to the actual utterance of the user. In some examples, the system(s) may compute a confidence score for each one of the predicted versions of the utterance, and the candidate having the highest confidence score may be selected, or the candidate having a confidence score that meets or exceeds some threshold may be selected.

In some examples, the actual version of the user utterance may differ from the selected predicted version of the utterance. For instance, if the user utterance is “what is the capital of Idaho and why was it chosen for the capital” and the predicted version of the utterance is “where is the capital of Idaho and why is that place the capital”, the system(s) may still select the predicted version of the utterance and use the response generated by the language model(s) for the predicted version of the utterance since the response may not change between the different prompts. That is, the response may still be something like “the capital of Idaho is Boise and it was chosen as Idaho's capital in 1864 due to its growing population, central location, and economic significance as a hub during the gold rush” based on either the actual utterance or the predicted version of the utterance.

In some examples, the system(s) may generate output audio data representing the response to the user utterance. That is, the system(s) may generate output audio data representative of a first candidate response to the utterance generated based on the first predicted version of the utterance, which was determined to correspond to the actual utterance. In some examples, to generate the output audio data, the system(s) may send the selected candidate response to a Text-to-Speech (TTS) system, module, or component of the conversational AI system. In some instances, this may include the system(s) sending, to the TTS system, first text data (or first tokens representing the first text data) representing a prefix of the response prior to the language model(s) generating second text data (or second tokens) representing a remainder of the response. In other words, the system(s) may start forwarding response tokens to the TTS system before the language model(s) fully completes generating the response. For instance, because language models typically generate one response per-prompt (or in this case, predicted utterance), pre-computing the response audio may not be wasteful. Furthermore, the language model(s) may generate tokens faster than the TTS system may utter them, so the system(s) may continue to stream output tokens to the TTS system.

Although many of the examples herein are described with respect to using language models, and specifically large language models (LLMs), this is not intended to be limiting. For example, and without limitation, any of the various language models and/or neural networks described herein may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-trained (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian Splat models, models with encoder-only architectures, models with decoder-only architectures, models with encoder-decoder architectures, generative machine learning models, large language models (LLMs), vision language models (VLMs), multi-modal language models (MMLMs), and/or other types of machine learning models.

In some examples, the language model(s) and/or other machine learning models described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications - such as NVIDIA's TensorRT), and/or enterprise management data for telemetry (e.g., including identity, metrics, health checks, and/or monitoring).

The model(s) described herein (e.g., the language model(s) or other model(s)) may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

In some embodiments, the systems and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs. In some examples, the talking or smart kiosk application may forward candidate utterance prefixes to the model(s) prior to an ASR system completing audio to text conversion, as well as predict different user utterances and preemptively begin responding to them without having to rely on other systems (e.g., ASR systems) to fully complete their operations.

In one or more embodiments, the systems and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on user-specified requests, in-game behavior, and/or pre-stored player profiles. For instance, the gaming application may forward candidate utterance prefixes to the model(s) prior to an ASR system completing audio to text conversion, as well as predict different user utterances and preemptively begin responding to them without having to rely on other systems (e.g., ASR systems) to fully complete their operations. In some embodiments, the systems may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the systems and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The systems may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the systems may enable users to interact with the video conferencing platform using natural language inputs. For example, users may issue voice commands to schedule, join, or leave meetings, or to manage participants and screen sharing, and the systems of the present disclosure may submit candidate versions of the voice commands to the model(s) prior to the voice command being completed, etc. During receiving and/or sending the data to and from the end-user or edge device(s), one or more data processing units (DPUs) and/or network interface cards (NICs) may be used.

In some embodiments, the systems and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform or respond to complex tasks autonomously or semi-autonomously, such as interacting with and/or manipulating static and/or dynamic objects, or navigating environments using sensors such as cameras, LiDAR, RADAR, ultrasonic sensors, and more. The systems may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers). In some instances, the systems of the present disclosure may be used by the robot to preemptively begin responding to spoken requests or commands prior to another system (e.g., ASR systems) fully completing its operations. For instance, if a user were to say to the robot “move the blue block to the northwest corner of the building,” the robot may use the techniques disclosed herein to begin responding to the request (e.g., by moving toward or beginning to pick up the blue block) prior to the user completing the full statement.

In some embodiments, the systems and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time. As described herein, the IVI systems may use the techniques of the present disclosure to begin processing/generating/responding to candidate utterance prefixes prior to an ASR and/or other system completing voice to text conversion, thereby improving the responsiveness of the IVI systems to user requests.

In some embodiments, one or more transformer engines (TEs) may be implemented. The transformer engine may use micro-tensor scaling to optimize performance and accuracy - such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for further increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

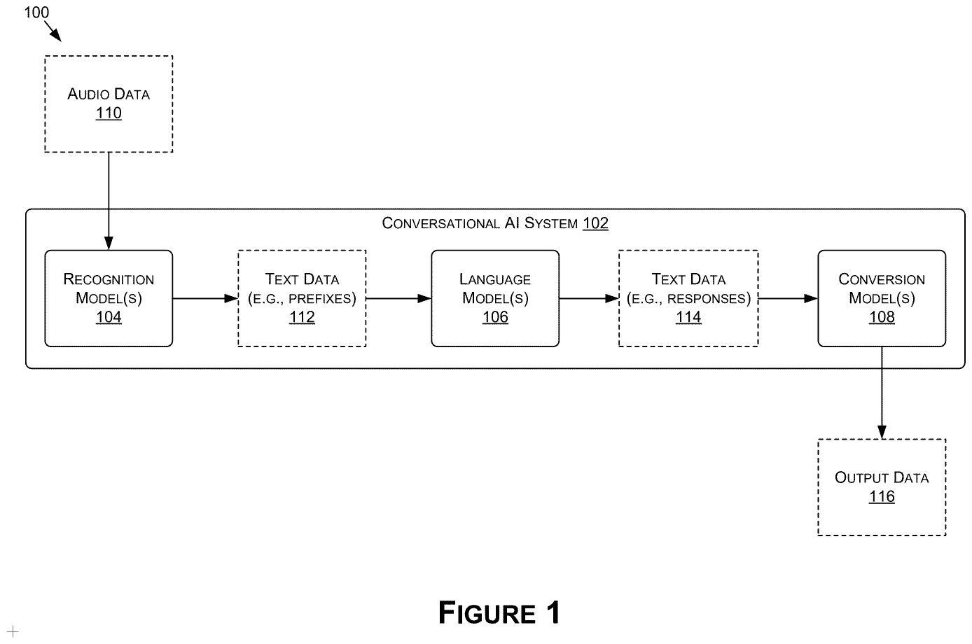

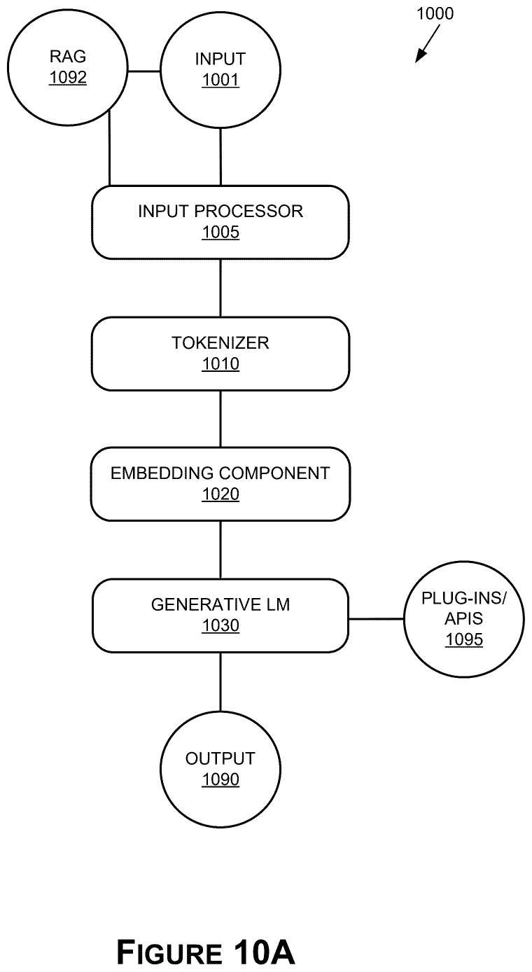

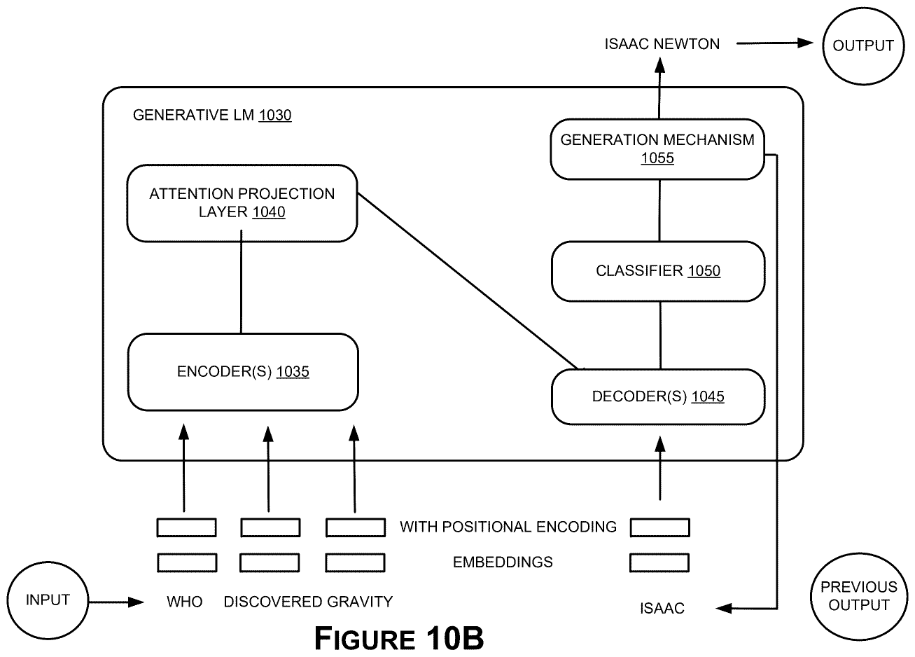

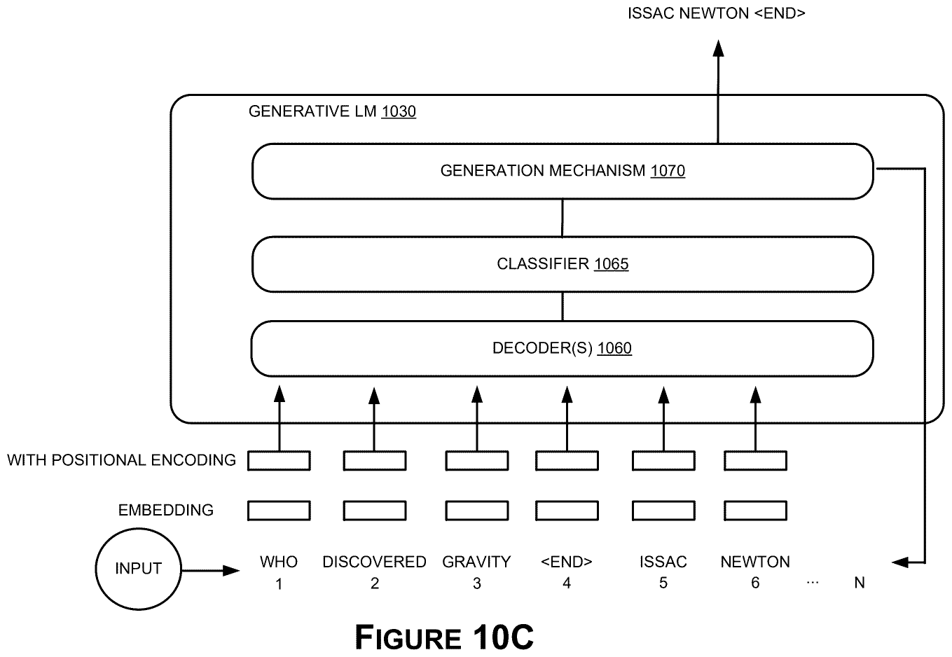

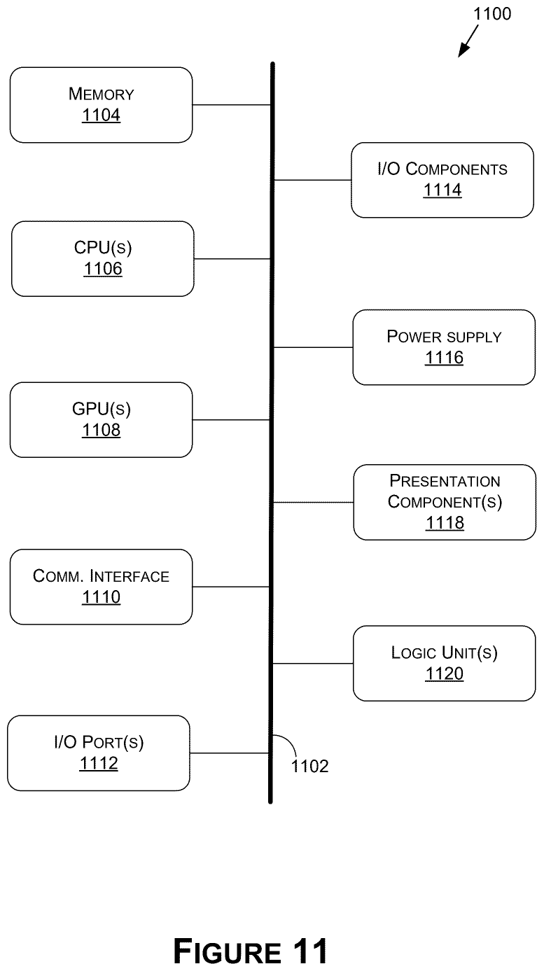

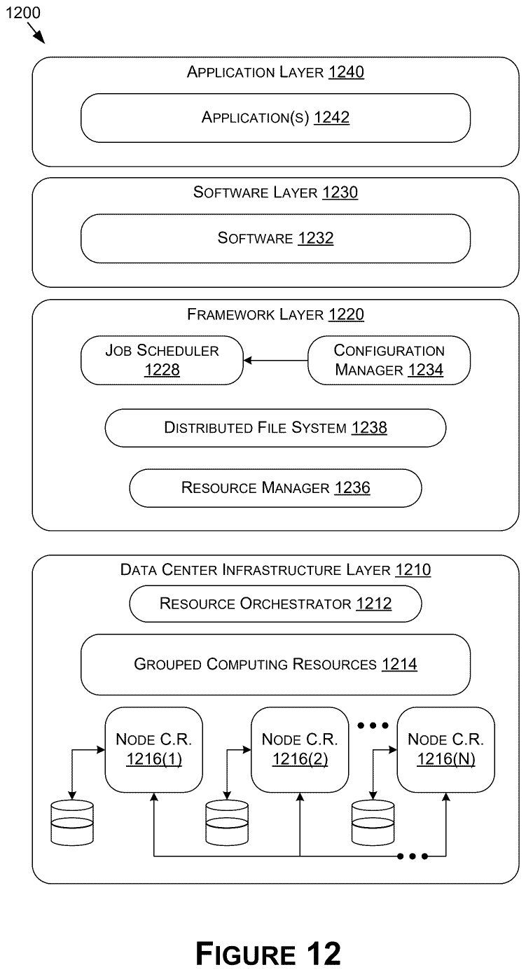

With reference to FIG. 1, FIG. 1 is a data flow diagram illustrating an example of a process 100 that may be performed by a conversational AI system 102 to generate a response to a user utterance, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 10A-10C), one or more computing devices or components thereof (e.g., as described in FIG. 11), and/or one or more data centers or components thereof (e.g., as described in FIG. 12).

The process 100 may be performed by the conversational AI system 102 using, amongst additional or alternative components, modules, or systems, one or more recognition models 104 (e.g., one or more ASR models), one or more language models 106, and one or more conversion models 108 (e.g., one or more TTS models). As a brief overview of the process 100, the conversational AI system 102 may obtain audio data 110 representing speech associated with an utterance. The conversational AI system 102 may use the recognition model(s) 104 to convert the audio data 110 into text data 112 (or tokens representing the text data), which may represent one or more predicted prefixes of the utterance and/or the complete utterance. The conversational AI system 102 may apply the text data 112—such as a portion representing the predicted prefix(es) of the utterance—to the language model(s) 106. The language model(s) 106 may process the text data 112 and generate a plurality of predicted versions of the utterance (also referred to herein as “predicted utterances”) and a plurality of responses to the predicted utterances. The language model(s) 106 may output text data 114 (or tokens representing the text data) representing one or more responses to the user utterance. The conversational AI system 102 may apply the text data 114 to the conversion model(s) 108 which may convert the text data 114 into output data 116, which may include audio data representing a spoken response to the utterance. In some examples, the text data 112 and 114 described with reference to FIG. 1 may additionally, or alternatively, include one or more of audio data, video data, image data, sensor data, 3D design data, USD data, or any other kind of data. Additionally, or alternatively, the text data 112 and 114 may include or be replaced with vector embeddings that the language model 106 can operate over natively without intermediate representations (e.g., text, etc.).

In some examples, the conversational AI system 102 may generate, obtain, receive, determine, and/or retrieve audio data 110 representing speech from a user. In some examples, the audio data 110 may be received from a client device (e.g., a computing device, a voice enabled device, etc.). As described herein, the speech may be associated with a user utterance, such as “what is the capital of Idaho and why was it chosen for the capital?”. The conversational AI system 102 may use the recognition model(s) 104 to process the audio data 110 and generate the text data 112 (e.g., and/or audio data, video data, image data, sensor data, 3D design data, USD data etc.) associated with the speech. In some examples, the recognition model(s) 104 may correspond to an ASR system, module, or component used by the conversational AI system 102. As such, in some examples, the text data 112 may be associated with a text transcript of the speech, such as by representing the words, style, punctuation, and/or the like that matches the speech. Additionally, in some examples, the text may be represented using one or more tokens, such as one or more tokens that represent portions of words, words, punctuation, symbols, letters, and/or so forth from the text.

However, as described herein, instead of waiting for the recognition model(s) 104 to finish generating a version of the text data 112 representing the entire user utterance, in some instances the conversational AI system 102 may obtain, from the recognition model(s) 104, a portion of the text data 112 (also referred to herein as the “first text data”) representing a plurality of predicted prefixes of the user utterance. In some examples, the recognition model(s) 104 may generate the plurality of predicted prefixes as part of processing the audio data 110 corresponding to the user utterance and determining the actual words or sequence of words included in the speech. As such, and as described in further detail herein, the predicted prefixes may be different from one another as the recognition model(s) 104 continues to process more and more of the audio data 110 and make predictions about what the user said based on context, phonemes included in the utterance, etc. As an example, for the utterance of “what is the capital of Idaho and why was it chosen for the capital?”, after the recognition model(s) 104 finishes processing a first portion of the audio data 110 corresponding to “what is the capital”, the plurality of predicted prefixes of the utterance included in the text data 112 may include, for instance, “what is the capital”, “what's the capital”, “what is a capital”, “what is a Capitol”, “what is a cap at all”, what is the cap it'll”, and/or other variations.

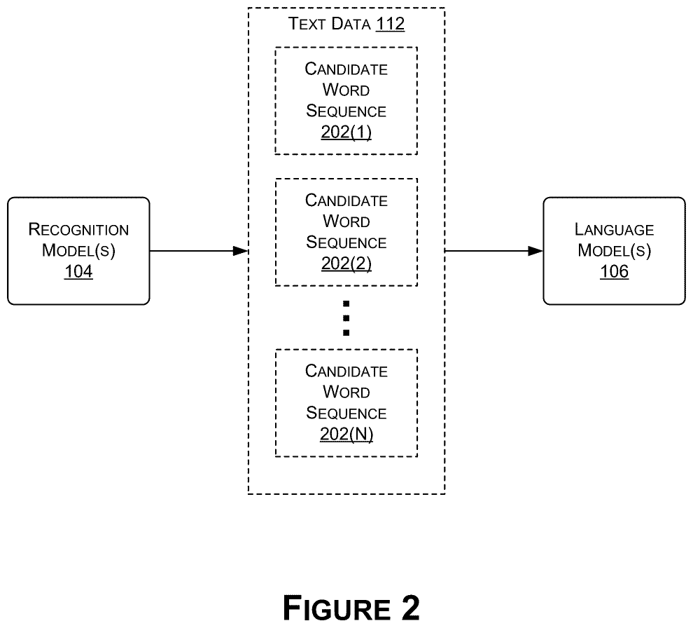

For instance, FIG. 2 illustrates example detail associated with the text data 112 of the example of FIG. 1, in accordance with some embodiments of the present disclosure. As shown, the text data 112 may include a plurality of candidate word sequences 202(1)-202(N), where “N” may represent any number of the candidate word sequences 202 included in the text data 112. The candidate word sequences 202 may correspond to respective ones of the predicted prefixes associated with the utterance. For instance, continuing the above example, the first candidate word sequence 202(1) may correspond to the predicted prefix of “what is the capital”, the second candidate word sequence 202(2) may correspond to the predicted prefix of “what's the capital,” and so forth. As shown, the text data 112 including the candidate word sequences 202 corresponding to the predicted prefixes may be applied to the language model(s) 106, and the candidate word sequences 202 may be determined by the recognition model(s) 104 as part of processing and converting the input audio data 110 into the text data 112.

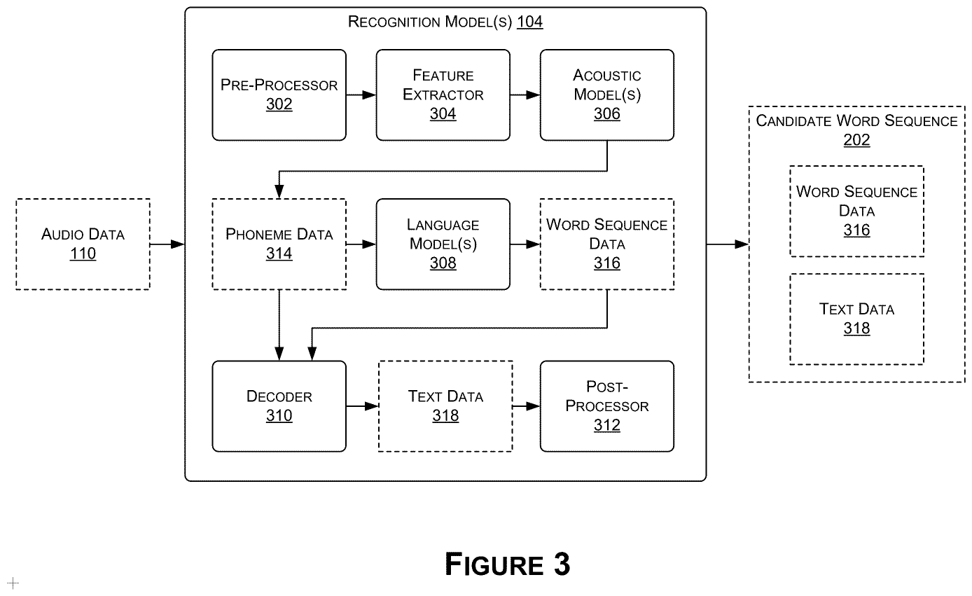

For instance, FIG. 3 is a data flow diagram illustrating an example of a process that may be performed by the recognition model(s) 104 to generate a candidate word sequence 202 from input audio data 110, in accordance with some embodiments of the present disclosure. As shown, the recognition model(s) 104 may include, amongst additional or alternative components, a pre-processors 302, a feature extractor 304, one or more acoustic models 306, one or more language models 308, a decoder 310, and a post-processor 312.

The recognition model(s) 104 may receive the audio data 110 (e.g., an audio waveform) representing the speech and/or utterance of the user. The recognition model(s) 104 may use the pre-processor 302 to process the audio data 110 to remove background noise and/or normalize volume levels. Additionally, the pre-processor 302 may segment the audio data 110 into smaller, manageable time frames to capture speech dynamics while preserving temporal resolution. The feature extractor 304 may then process the updated audio data 110 and extract various key features—such as Mel Frequency Cepstral Coefficients (MFCCs)—from the audio data 110 to represent the speech signal's phonetic and/or spectral properties. This step may reduce the audio data's complexity while retaining information critical for recognizing speech.

The recognition model(s) 104 may use the acoustic model(s) 306 to take the features extracted from the speech signal (e.g., Mel Frequency Cepstral Coefficients or MFCCs) and use statistical or neural network-based models to output phoneme probabilities, which may be represented by the phoneme data 314. These phonemes may correspond to the smallest units of sound in a language, such as the “p” in “pat” or the “th” in “think.” The acoustic model(s) 306 may, in some instances, be trained on large datasets of labeled audio and learn patterns that correlate specific sound features with corresponding phonemes. The output of the acoustic model(s) 306—the phoneme data 314—may typically include a sequence of probability distributions, where each frame of audio is mapped to the likelihood of various phonemes. This phoneme data 314 may then be used in conjunction with lexical and/or language models (e.g., the language model(s) 308) to construct coherent words and phrases in the final transcription.

The recognition model(s) 104 may use the language model(s) 308 to process the phoneme data 314 and predict the most likely sequence of words based on grammar, syntax, and/or word usage patterns. These most likely sequences of words may be represented using the word sequence data 316. In some examples, the language model(s) 308 may help refine the transcription by prioritizing plausible word combinations over unlikely ones. The language model(s) 308 may work in tandem with the phoneme data 314 by leveraging contextual probabilities to resolve ambiguities that arise from phoneme similarities or audio noise. For instance, if the phoneme data 314 suggests a choice between “their” and “there,” the language model(s) 308 may evaluate the surrounding words and grammatical structure to select the most appropriate word. Advanced language models, such as neural network-based approaches (e.g., transformers or recurrent neural networks), may be used to further enhance accuracy by understanding deeper contextual relationships within the text. Additionally, the language model(s) 308 may incorporate domain-specific training to handle specialized vocabularies or unique phrasing patterns, such as technical jargon, regional dialects, or industry-specific terminology. This customization may improve the transcription's relevance and usability across different applications, from virtual assistants to automated transcription services.

In some examples, the language model(s) may sequentially build on the predicted word sequences by processing new portions of data (e.g., words or phrases) at a time, leveraging the context from previous portions to refine predictions for subsequent ones. This approach may ensure that the transcription evolves dynamically and remains coherent as more information becomes available. For instance, the language model(s) 308 may start by analyzing a first portion of the phoneme data 314, predicting the most probable word(s) based on the acoustic evidence and linguistic context. For instance, if the audio begins with a phoneme resembling “wh,” the model might predict words like “what” or “where.” As the next portion of phoneme data 314 is processed, the language model(s) 308 may incorporate the previously predicted words to evaluate the likelihood of subsequent words. For example, after predicting “What is,” it is more likely to predict “the” or “a” than unrelated words like “cat” or “run.” The language model(s) 308 may continuously revise its predictions as new portions of data are added, the language model(s) 308 may reevaluate earlier choices based on the broader context provided by later data. For instance, if the language model(s) 308 initially predicts “I scream” but later processes “for ice cream,” it may retroactively adjust the earlier prediction to “ice cream” for coherence. As the language model(s) 308 processes each new portion of data, it may generate a growing word sequence (represented using the word sequence data 316) that reflects the evolving understanding of the input audio data 110, and these intermediate or growing word sequences may be what is applied to the language model(s) 106 of the conversational AI system 102 and used to generate the predicted utterances and/or responses while reducing latency.

In some examples, the recognition model(s) 104 may use the decoder 310 to, effectively, combine all the models of the recognition model(s) 104 (e.g., the acoustic model(s) 306, lexical models, and/or the language model(s) 308) and/or their outputs to determine the most probable text data 318 representation of the audio data 110. This may involve using the decoder 310 to search through possible combinations of phonemes and words to find the best match. The output text data 318 may then be refined using the post-processor 312 to fix errors, apply punctuation, and format the text data 318 for readability. Additionally, in some instances, contextual rules or user-specific adaptations may be applied by the post-processor 312 to enhance the final transcription's accuracy. As shown, the candidate word sequence 202 may include the word sequence data 316 and/or the text data 318.

Referring back to the example of FIG. 1, in some examples, the conversational AI system 102 may apply the text data 112 representing the plurality of predicted prefixes as input prompts to the language model(s) 106 (e.g., one or more large language models (LLM) or any other type of language model). For instance, the conversational AI system 102 may apply the plurality of predicted prefixes as the input prompts to the language model(s) 106 prior to obtaining one or more remainders of the utterance prefixes and/or the complete utterance (e.g., second text data representing updated versions of the prefixes and/or the remainder of the utterance). As an example, the conversational AI system 102 may apply the plurality of predicted prefixes to the language model(s) 106 and, in the input prompt(s), instruct the language model(s) 106 to complete the utterance and generate responses to the utterance.

In some examples, based at least on applying the plurality of predicted prefixes of the utterance as part of the input prompt(s) to the language model(s) 106, the language model(s) 106 may process the input prompt(s) (e.g., the first text data and/or first tokens representing the first text data) and generate a plurality of predicted versions of the utterance and a plurality of candidate responses to the predicted versions of the utterance. For instance, the plurality of predicted prefixes may be fed into the language model(s) 106 as a single batch, amortizing the computing cost across multiple potential utterances. Additionally, when the “temperature” of the language model(s) 106 is non-zero, each predicted prefix may be duplicated in the same batch, but resulting in slightly different ways of completing each candidate.

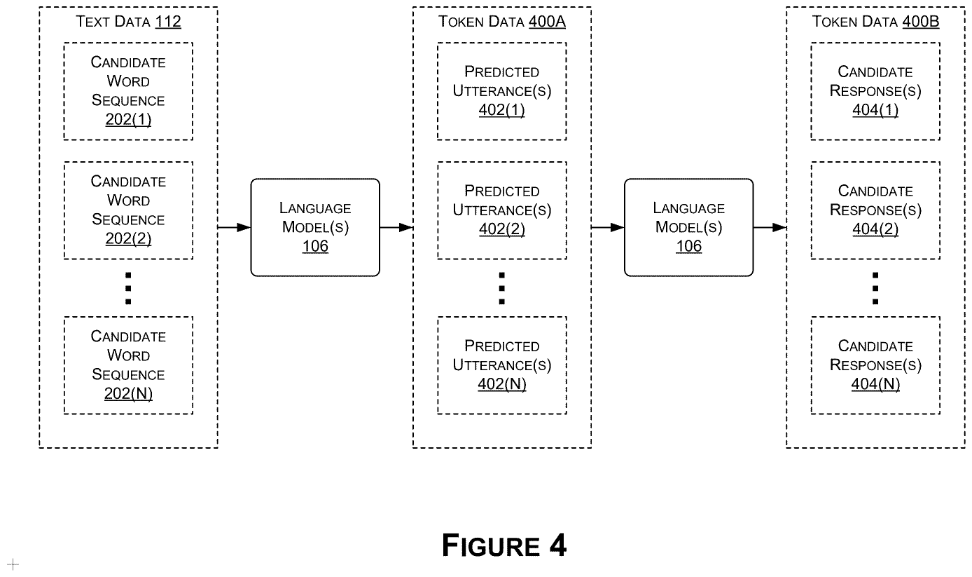

For instance, FIG. 4 illustrates an example of using the language model(s) 106 of the conversational AI system 102 to generate a plurality of predicted utterances and candidate responses based on candidate word sequences, in accordance with some embodiments of the present disclosure. As shown, the text data 112 including the candidate word sequences 202 may be applied to the language model(s) 106, and the language model(s) 106 may process the text data 112 and generate first token data 400A representing a plurality of predicted utterances 402(1)-402(N), where “N” may correspond to any number of the predicted utterances 402. In some examples, and as explained herein, the language model(s) 106 may generate one or more predicted utterances for each candidate word sequence 202(1). For instance, the language model(s) 106 may generate one or more first predicted utterances 402(1) based on the first candidate word sequence 202(1), one or more second predicted utterances 402(2) based on the second candidate word sequence 202(2), and so forth. As an example, if the first candidate word sequence 202(1) (e.g., first predicted prefix of the utterance) is “what is the capital”, the input may be duplicated and the language model(s) 106 may complete the prefix multiple times as “what is the capital of the world?”, “what is the capital of the United States?”, “what is the capital of Idaho?”, and so forth. Additionally, if the second candidate word sequence 202(2) (e.g., second predicted prefix of the utterance) is “what is a capital”, the input may be duplicated and the language model(s) 106 may complete the prefix multiple times as “what is a capital letter?”, “what is a capital offense?”, “what is a capital gain?”, and so forth.

Additionally, the language model(s) 106 may generate second token data 400B that represents a plurality of candidate responses 404(1)-404(N) to the predicted utterances 402. Continuing the above example, a candidate response 404 may be generated for each predicted utterance of the predicted utterances 402. For instance, the language model(s) 106 may generate one or more first candidate responses 404(1) that correspond to the first predicted utterance(s) 402(1), one or more second candidate responses 404(2) that correspond to the second predicted utterance(s) 402(2), and so forth. As an example, for the predicted utterance of “what is the capitol building” the language model(s) 106 may generate a candidate response of “the Capitol building is where the United States Congress meets in Washington, D.C., and it houses the Senate and the House of Representatives”, for the predicted utterance of “what is the capital of the United States” the language model(s) 106 may generate a candidate response of “the capital of the United States is Washington, D.C.”, for the predicted prefix of “what is the capital of Idaho” the language model(s) 106 may generate a candidate response of “the capital of Idaho is Boise”, for the predicted prefix of “what is a capital” the language model(s) 106 may generate a candidate response of “a capital is a city where a government's central offices and leaders are located”, and so forth.

In some examples, the language model(s) 106 illustrated in the example of FIG. 4 may be the same or different language models. For example, in some instances the conversational AI system 102 may use a single language model to generate the predicted versions of the utterance and the candidate responses. In such instances, the conversational AI system 102 may update one or more parameters of the language model to adjust the temperature of the model between the generation of the predicted utterances and the generation of the candidate responses. That is, the language model's temperature may be adjusted after and “end of prompt” token (or similar) to reduce the amount of randomness in generated responses to the prompt. Additionally, or alternatively, the language model may be halted at the end of prompt token to avoid over-computing potential responses, especially when the initial query from the user has a lot of uncertainty. In some examples, instead of using a single language model, the conversational AI system 102 may use a first language model to generate the predicted versions of the utterance and a second language model to generate the candidate responses to the predicted versions of the utterances. The first language model may be associated with a first temperature such that the first language model generates more diverse and/or creative predicted utterances, while the second language model may be associated with a second temperature such that the second language model reduces the amount of randomness in generated responses to the predicted utterances.

Referring back to the example of FIG. 1, in some instances, the conversational AI system 102 may obtain additional information from the recognition model(s) 104 (e.g., the second text data or a portion of the second text data representing at least a portion of the remainder of the utterance) and use it to update the language model(s) 106, its outputs, confidence scores, etc. For example, as the recognition model(s) 104 continue to process the input audio data 110, the language model(s) 308 of the recognition model(s) 104 may determine with relatively high confidence that the prefix of the utterance “what is the capital of Idaho and why was it chosen for the capital?” includes the text “what is the capital of Idaho and why . . . ”. Although the recognition model(s) 104 may still continue to further process the audio data 110 to eventually determine the complete user utterance, this updated word sequence may be forwarded to the language model(s) 106. The language model(s) 106 may then use this updated word sequence to adjust its own predictions and outputs.

In some examples, a key-value (KV) cache of the prefill/decode steps of each predicted utterance candidate and corresponding response may be saved, and when the recognition model(s) 104 further narrows down candidates and/or produces additional words, the language model(s) 106 may retrieve prefix-matched KV cache entries to continue prefill/decode steps without recomputing over previously-seen tokens. In other words, the language model(s) 106 may use the updated predicted word sequences from the recognition model(s) 104 to fetch those KV cache entries that include the text of “what is the capital of Idaho and why” and continue further processing to predict the utterance with these candidates. For instance, the language model(s) 106 may generate predicted utterances that recite “what is the capital of Idaho and why is Idaho famous for potatoes?”, “what is the capital of Idaho and why is Idaho called the gem state?”, “what is the capital of Idaho and why is the weather there constantly changing?”, and so forth. Additionally, the language model(s) 106 may generate or update its candidate responses bases on these predicted utterances, as described herein.

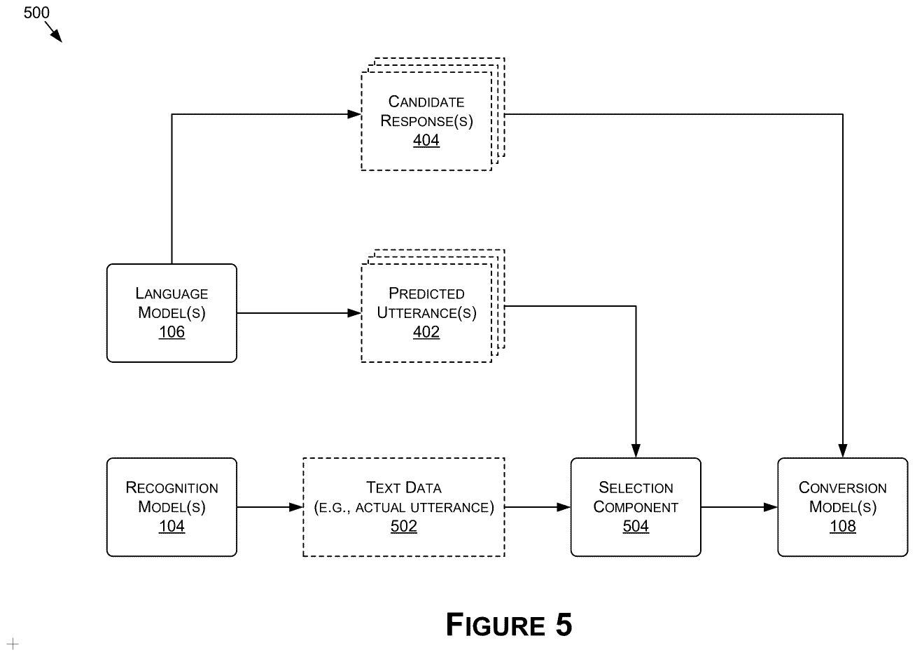

In some instances, the conversational AI system 102 may determine that a first predicted version of the utterance (e.g., from the plurality of predicted versions of the utterance) corresponds to the actual version of the utterance. For instance, FIG. 5 is a data flow diagram illustrating an example of a process 500 for selecting a candidate response, in accordance with some embodiments of the present disclosure. As shown, a selection component 504—which may be another component of the conversational AI system 102—may obtain text data 502 representing the actual version of the utterance from the recognition model(s) 104 and compare it with the predicted utterance(s) 402 to determine which predicted utterance corresponds to the actual utterance of the user. In some examples, the selection component 504 may compute a confidence score for each one of the predicted utterance(s) 402, and the candidate having the highest confidence score may be selected, or the candidate having a confidence score that meets or exceeds some threshold may be selected.

In some instances, the selection component 504 may indicate to the conversion model(s) 108 which candidate response of the candidate response(s) 404 to use for the output. For instance, the predicted utterance(s) 402 may be mapped to the candidate response(s) 404 and/or assigned a unique identifier, and the selection component 504 may convey this information to the conversion model(s) 108 so that it selects the correct response to output. Additionally, or alternatively, in some instances the predicted utterance(s) 402 and their corresponding candidate response(s) 404 may be represented using a single text string or group of tokens and kept together (e.g., as opposed to being separate portions of data as illustrated in the example of FIG. 5) but separated using an end of prompt token (or similar), and the selection component 504 may, after determining the correct predicted utterance/candidate response pair to use, may forward the portion of the text string or tokens (that correspond to the response) to the conversion model(s) 108. While these are just a couple of examples of how the conversational AI system 102 may select the candidate response to output based on determining which predicted utterance corresponds to the actual utterance, in additional or alternative examples, any number of methods or techniques may be used for the conversational AI system 102 to select the correct, precomputed response to output.

Additionally, in some instances the actual version of the user utterance may differ from the selected predicted utterance. For instance, if the user utterance is “what is the capital of Idaho and why was it chosen for the capital” and the predicted version of the utterance is “where is the capital of Idaho and why is that place the capital”, the selection component 504 may determine that the two utterance are above a threshold similarity with one another and use the response generated by the language model(s) 106 for that predicted utterance since the response may not change between the different prompts. That is, the response may still be something like “the capital of Idaho is Boise and it was chosen as Idaho's capital in 1864 due to its growing population, central location, and economic significance as a hub during the gold rush” based on either the actual utterance or the predicted utterance.

Referring back to the example of FIG. 1, the process 100 may include the conversational AI system 102 using the conversion model(s) 108 to generate output data 116 representing the response to the user utterance. For example, the conversion model(s) 108 may perform TTS conversion to convert the text data 114 (e.g., and/or the audio data, video data, image data, sensor data, 3D design data, USD data, etc.) representing a response to the utterance into audio data representing speech (e.g., a spoken response to the utterance). In some examples, a first portion of the text data 114 (or first tokens representing the first text data 114) representing a prefix of the response may be sent to the conversion model(s) 108 prior to the language model(s) 106 generating a second portion of the text data 114 (or second tokens) representing a remainder of the response. In other words, the conversational AI system 102 and/or the language model(s) 106 may start forwarding response tokens to the conversion model(s) 108 before the language model(s) 106 fully completes generating the response. For instance, because language models typically generate one response per-prompt (or in this case, predicted utterance), pre-computing the response audio may not be wasteful. Furthermore, the language model(s) 106 may generate tokens faster than the conversion model(s) 108 may utter them, so the conversational AI system 102 may continue to stream output tokens to the conversion model(s) 108.

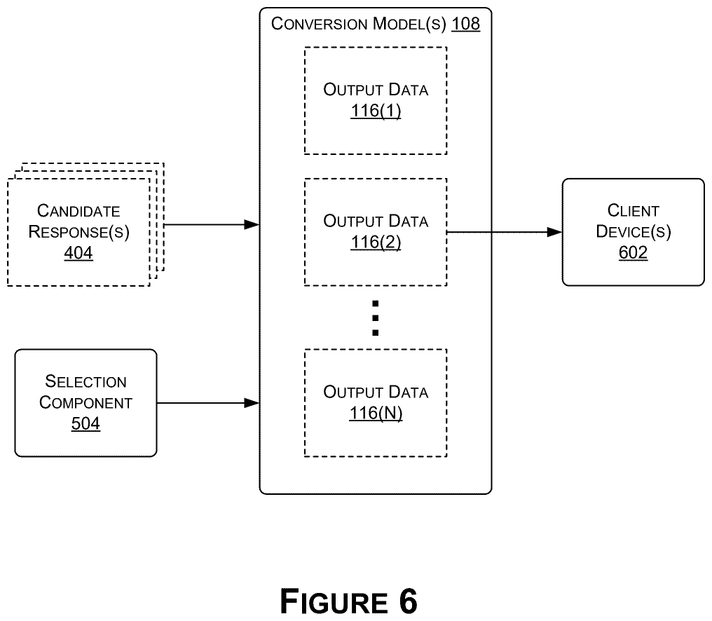

For instance, FIG. 6 illustrates an example of using the conversion model(s) 108 to precompute different versions of output data 116(1)-116(N), in accordance with some embodiments of the present disclosure. In some examples, each different version of the output data 116 may correspond to (e.g., be generated using and/or represent) a different candidate response of the candidate response(s) 404. For example, the candidate response(s) 404 (e.g., text data or tokens representing the candidate response(s) 404) may be streamed to the conversion model(s) 108, and the conversion model(s) 108 may begin to convert each of the candidate response(s) 404 into the output data 116 prior to the correct response being selected and/or completed. In other words, as the language model(s) 106 outputs the candidate response(s) 404, they may be fed into the conversion model(s) 108 instead of waiting for the language model(s) 106 to complete generating the candidate response(s) 404. The selection component 504 may then indicate to the conversion model(s) 108 which version of the output data 116 to send to one or more client devices 602. For instance, in the example of FIG. 6, the selection component 504 may indicate to send the second version of the output data 116(2) to the client device(S) 602. Additionally, or alternatively, the conversion model(s) 108 may send the different versions of the output data 116 to some other component (e.g., a planning component) of the conversational AI system 102, and the other component may receive the selection from the selection component and output the correct response.

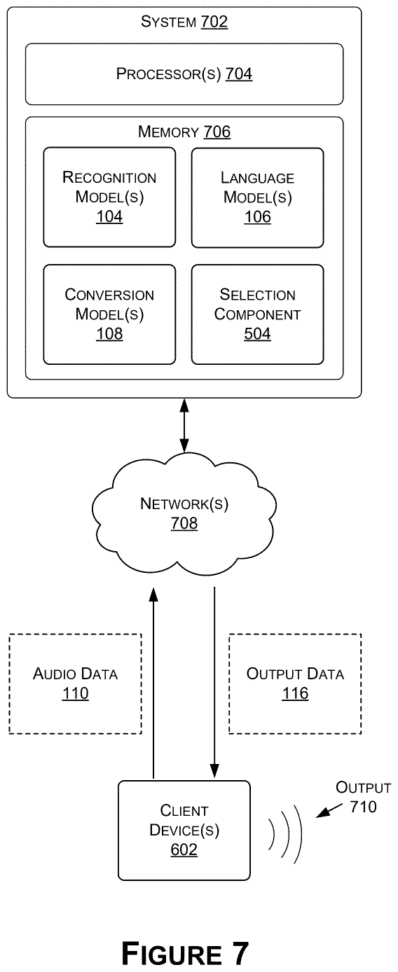

Referring now to FIG. 7, FIG. 7 illustrates an example of a system 702 that may perform one or more of the processes described herein, in accordance with some embodiments of the present disclosure. As shown, the system 702 (which may represent, and/or include, an example computing device(s) 1100 and/or an example data center 1200) may include one or more processors 704 (which may be similar to, and/or include, one or more central processing units 1106 and/or one or more graphics processing units 1108) and memory 706 (which may be similar to, and/or include, a memory 1104). For instance, the memory 706 may store the recognition model(s) 104, the language model(s) 106, the conversion model(s) 108, and/or the selection component 504. Additionally, the processor(s) 704 may execute the recognition model(s) 104, the language model(s) 106, the conversion model(s) 108, and/or the selection component 504 to perform one or more of the processes described herein. In some examples, the system 702 may correspond to the conversational AI system 102.

Additionally, as shown by the example of FIG. 7, the system 702 may receive the audio data 110 from the client device(s) 602 (which may also be similar to, and/or include, an example computing device 1100) and/or send the output data 116 to the client device(s) 602. For instance, the client device(s) 602 may use one or more input devices, such as one or more microphones, to generate the audio data 110. The client device(s) 602 may also include one or more output devices, such as one or more speakers, to output 710 sound associated with the output data 116. For instance, in some examples, the audio data 110 may represent a query and the output data 116 may represent a response to the query. While the example of FIG. 7 illustrates the output 710 as being associated with audio, in other examples, the output may include any other type of output, such as content that is visually displayed by the client device(s) 602 (e.g., on a screen).

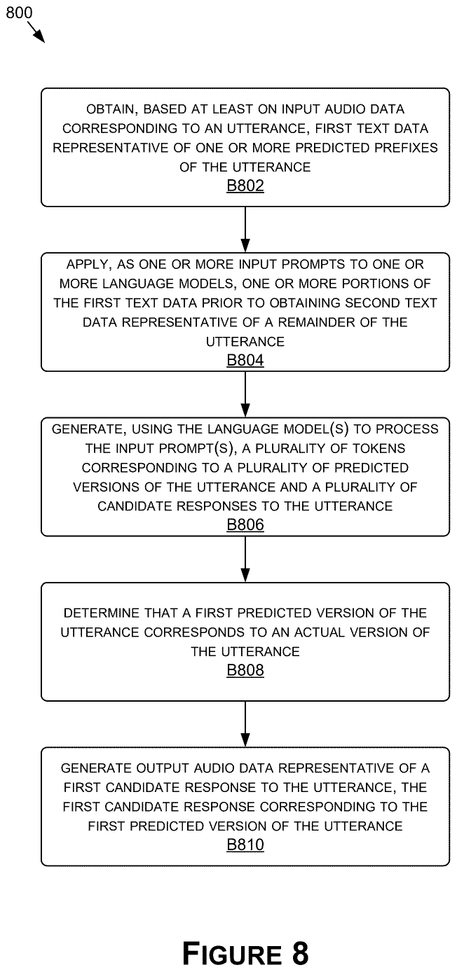

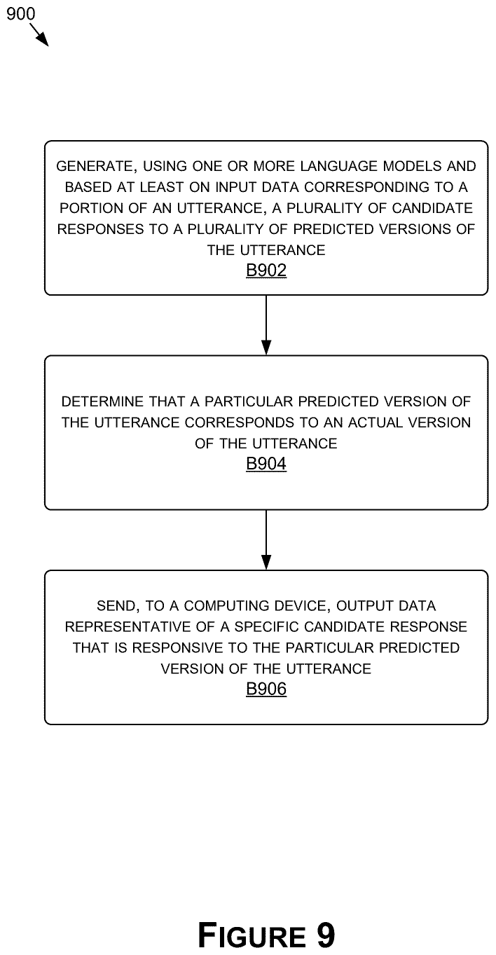

Now referring to FIGS. 8 and 9, each block of method 800 and 900, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 800 and 900 are described, by way of example, with respect to the system of FIG. 1. However, these methods may additionally or alternatively be executed by any one system, or any combination of systems, including, but not limited to, those described herein.

FIG. 8 is a flow diagram illustrating an example of a method 800 for reducing response times in conversational AI systems, in accordance with some embodiments of the present disclosure. The method 800, at block B802, includes obtaining, based at least on input audio data corresponding to an utterance, first text data representative of one or more predicted prefixes of the utterance. For instance, the conversational AI system 102 may obtain the text data 112 representative of the predicted prefix(es) of the utterance represented in the audio data 110.

The method 800, at block B804, includes applying, as one or more input prompts to one or more language models, one or more portions of the first text data prior to obtaining second text data representative of a remainder of the utterance. For instance, the conversational AI system 102 may apply the portion(s) of the text data 112 as the input prompt(s) to the language model(s) 106 prior to obtaining the complete, ASR translated utterance from the recognition model(s) 104 and/or an updated version of a candidate word sequence.

The method 800, at block B806, includes generating, using the language model(s) to process the input prompt(s), a plurality of tokens corresponding to a plurality of predicted versions of the utterance and a plurality of candidate responses to the utterance. For instance, the conversational AI system 102 may use the language model(s) 106 process the input prompt(s) and generate the text data 114 (and/or tokens representing the text data 114), where the text data 114 may represent the predicted versions of the utterance and/or the plurality of candidate responses to the utterance.

The method 800, at block B808, includes determining that a first predicted version of the utterance corresponds to an actual version of the utterance. For instance, the conversational AI system 102 (or a component thereof, such as the selection component 504) may determine that the first predicted version of the utterance corresponds to the actual version of the utterance based at least on obtaining additional information from the recognition model(s) 104 responsive to the recognition model(s) 104 continuing to process the audio data 110.

The method 800, at block B810, includes generating output audio data representative of a first candidate response to the utterance, the first candidate response corresponding to the first predicted version of the utterance. For instance, the conversational AI system 102 may use the conversion model(s) 108 to generate the output data 116 representing the first candidate response to the utterance, where the first candidate response corresponds to the first predicted version of the utterance. That is, the first candidate response may be generated by the language model(s) 106 as a response to the first predicted version of the utterance.

FIG. 9 is a flow diagram illustrating an example of a method for precomputing responses to predicted user utterances to reduce conversational AI system latencies, in accordance with some embodiments of the present disclosure. The method 900, at block B902, includes generate, using one or more language models and based at least on input data corresponding to a portion of an utterance, a plurality of candidate responses to a plurality of predicted versions of the utterance. For instance, the conversational AI system 102 may use the language model(s) 106 to generate the plurality of candidate responses to the plurality of predicted versions of the utterance. In some examples, the language model(s) 106 may generate the predicted versions of the utterance based at least on the input data representing a plurality of candidate prefixes of the utterance determined using the recognition model(s) 104.

The method 900, at block B904, includes determine that a particular predicted version of the utterance corresponds to an actual version of the utterance. For instance, the conversational AI system 102 may determine that the particular predicted version of the utterance corresponds to the actual version of the utterance bases on comparing the particular predicted version of the utterance to the actual version of the utterance received from the recognition model(s) 104 based on the recognition model(s) 104 finishing processing the audio data 110.

The method 900, at block B906, includes sending, to a computing device, output data representative of a specific candidate response that is responsive to the particular predicted version of the utterance. For instance, the conversational AI system 102 may send the output data 116 to the computing device (e.g., the client device(s) 602), and the output data 116 may represent the specific candidate response that is responsive to the particular predicted version of the utterance. In other words, the specific candidate response may be generated by the language model(s) 106 as a response to the particular predicted version of the utterance. In some examples, the conversational AI system 102 may use the conversion model(s) 108 to convert text data 114 representing the specific candidate response into audio data representing a spoken version of the response.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) - such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources - such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents - which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use - or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer 1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: obtaining, based at least on input audio data corresponding to an utterance, first text data representative of one or more predicted prefixes of the utterance; applying, as one or more input prompts to one or more language models, one or more portions of the first text data prior to obtaining second text data representative of a remainder of the utterance; generating, prior to completion of an actual version of the utterance and based at least on the one or more language models processing the one or more input prompts, a plurality of tokens corresponding to a plurality of predicted versions of the utterance and a plurality of candidate responses to the utterance; determining that a predicted version of the utterance from the plurality of predicted versions of the utterance corresponds to the actual version of the utterance; and generating output audio data representative of a candidate response to the utterance, the candidate response corresponding to the predicted version of the utterance.
B. The method of paragraph A, wherein the generating of the output audio data comprises sending, to a Text-to-Speech (TTS) component, one or more first tokens corresponding to a prefix of the candidate response prior to the one or more language models generating one or more second tokens corresponding to a remainder of the candidate response.
C. The method of any one of paragraphs A-B, wherein the generating of the output audio data comprises sending, to a Text-to-Speech (TTS) component, third text data corresponding to a prefix of the first candidate response prior to the one or more language models outputting additional text data corresponding to a remainder of the first candidate response.
D. The method of any one of paragraphs A-C, further comprising: obtaining the second text data corresponding to the remainder of the utterance; and comparing the second text data with third text data corresponding to the plurality of tokens, wherein the determining that the predicted version of the utterance corresponds to the actual version of the utterance is based at least on the comparing.
E. The method of any one of paragraphs A-D, further comprising: obtaining third text data corresponding to a portion of the remainder of the utterance; and computing, based at least on the third text data, a confidence score associated with the predicted version of the utterance, wherein the determining that the predicted version of the utterance corresponds to the actual version of the utterance is based at least on a magnitude of the confidence score meeting or exceeding a threshold value.
F. The method of any one of paragraphs A-E, wherein the one or more language models include one or more multi-modal language models and the output audio data is generated using the one or more multi-modal language models.
G. The method of any one of paragraphs A-F, further comprising: predicting the end of the utterance; and altering one or more parameters of the one or more language models responsive to the end of the utterance to adjust a temperature of the one or more language models.
H. A system comprising: one or more processors to: generate, using one or more language models and based at least on input data corresponding to a portion of an utterance received prior to completion of the utterance, a plurality of candidate responses to a plurality of predicted versions of the utterance; upon completion of the utterance and prior to generating a response to the utterance, determine that a particular predicted version of the utterance corresponds to an actual version of the utterance; and send, to a computing device, output data representative of a specific candidate response that is responsive to the particular predicted version of the utterance that was generated prior to the completion of the utterance.
I. The system of paragraph H, the one or more processors further to compute a confidence score associated with the particular predicted version of the utterance, wherein the determination that the particular predicted version of the utterance corresponds to the actual version of the utterance is based at least on the confidence score meeting or exceeding a threshold.
J. The system of any one of paragraphs H-I, the one or more processors further to: obtain data representative of one or more second portions of the utterance; and compare the data to the plurality of predicted versions of the utterance, wherein the determination that the particular predicted version of the utterance corresponds to the actual version of the utterance is based at least on the comparison.
K. The system of any one of paragraphs H-J, the one or more processors further to apply, to the one or more language models, the input data prior to obtaining second input data corresponding to one or more second portions of the utterance.
L. The system of any one of paragraphs H-K, the one or more processors further to: generate, using one or more Automatic Speech Recognition (ASR) components to process audio data representing the utterance, first text data corresponding to a plurality of predicted prefixes of the utterance; and apply, as the input data to the one or more language models, at least a portion of the first text data corresponding to a first predicted prefix of the plurality of predicted prefixes.
M. The system of any one of paragraphs H-L, the one or more processors further to: generate, using one or more second language models and based at least on the input data, the plurality of predicted versions of the utterance, wherein the one or more language models are associated with a first temperature and the one or more second language models are associated with a second temperature.
N. The system of any one of paragraphs H-M, the one or more processors further to: generate, using the one or more language models and based at least on the input data, the plurality of predicted versions of the utterance; and update a temperature of the one or more language models subsequent to the generation of the plurality of predicted versions of the utterance and prior to the generation of the plurality of candidate responses.
O. The system of any one of paragraphs H-N, the one or more processors further to: apply, to a Text-to-Speech (TTS) component, first text data corresponding to a first portion of the specific candidate response prior to obtaining second text data corresponding to a second portion of the specific candidate response; and generate, using the TTS component to process the first text data and the second text data, the output data.
P. The system of any one of paragraphs H-O, wherein: the portion of the utterance corresponds to a first predicted prefix of the utterance, and the plurality of predicted versions of the utterance include at least one of the first predicted prefix or one or more second predicted prefixes of the utterance.
Q. The system of any one of paragraphs H-P, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.
R. One or more processors comprising: processing circuitry to cause presentation of a response to an utterance, the response generated based at least on using one or more language models to process first data representative of one or more predicted prefixes of the utterance prior to obtaining second data representative of at least one of one or more predicted remaining portions of the utterance or an actual version of the utterance.
S. The one or more processors of paragraph R, the processing circuitry further to: generate, using the one or more language models, one or more first tokens corresponding to a predicted version of the utterance; update a temperature of the one or more language models subsequent to the generation of the one or more first tokens; and generate, using the one or more language models and subsequent to updating the temperature, one or more second tokens corresponding to the response.
T. The one or more processors of any one of paragraphs R-S, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

What is claimed is:

1. A method comprising:
obtaining, based at least on input audio data corresponding to an utterance, first text data representative of one or more predicted prefixes of the utterance;
applying, as one or more input prompts to one or more language models, one or more portions of the first text data prior to obtaining second text data representative of a remainder of the utterance;
generating, prior to completion of an actual version of the utterance and based at least on the one or more language models processing the one or more input prompts, a plurality of tokens corresponding to a plurality of predicted versions of the utterance and a plurality of candidate responses to the utterance;
determining that a predicted version of the utterance from the plurality of predicted versions of the utterance corresponds to the actual version of the utterance; and
generating output audio data representative of a candidate response to the utterance, the candidate response corresponding to the predicted version of the utterance.

2. The method of claim 1, wherein the generating of the output audio data comprises sending, to a Text-to-Speech (TTS) component, one or more first tokens corresponding to a prefix of the candidate response prior to the one or more language models generating one or more second tokens corresponding to a remainder of the candidate response.

3. The method of claim 1, wherein the generating of the output audio data comprises sending, to a Text-to-Speech (TTS) component, third text data corresponding to a prefix of the first candidate response prior to the one or more language models outputting additional text data corresponding to a remainder of the first candidate response.

4. The method of claim 1, further comprising:
obtaining the second text data corresponding to the remainder of the utterance; and
comparing the second text data with third text data corresponding to the plurality of tokens,
wherein the determining that the predicted version of the utterance corresponds to the actual version of the utterance is based at least on the comparing.

5. The method of claim 1, further comprising:
obtaining third text data corresponding to a portion of the remainder of the utterance; and
computing, based at least on the third text data, a confidence score associated with the predicted version of the utterance,
wherein the determining that the predicted version of the utterance corresponds to the actual version of the utterance is based at least on a magnitude of the confidence score meeting or exceeding a threshold value.

6. The method of claim 1, wherein the one or more language models include one or more multi-modal language models and the output audio data is generated using the one or more multi-modal language models.

7. The method of claim 1, further comprising:
predicting the end of the utterance; and
altering one or more parameters of the one or more language models responsive to the end of the utterance to adjust a temperature of the one or more language models.

8. A system comprising:
one or more processors to:
generate, using one or more language models and based at least on input data corresponding to a portion of an utterance received prior to completion of the utterance, a plurality of candidate responses to a plurality of predicted versions of the utterance;
upon completion of the utterance and prior to generating a response to the utterance, determine that a particular predicted version of the utterance corresponds to an actual version of the utterance; and
send, to a computing device, output data representative of a specific candidate response that is responsive to the particular predicted version of the utterance that was generated prior to the completion of the utterance.

9. The system of claim 8, the one or more processors further to:
compute a confidence score associated with the particular predicted version of the utterance,
wherein the determination that the particular predicted version of the utterance corresponds to the actual version of the utterance is based at least on the confidence score meeting or exceeding a threshold.

10. The system of claim 9, the one or more processors further to:
obtain data representative of one or more second portions of the utterance; and
compare the data to the plurality of predicted versions of the utterance,
wherein the determination that the particular predicted version of the utterance corresponds to the actual version of the utterance is based at least on the comparison.

11. The system of claim 8, the one or more processors further to apply, to the one or more language models, the input data prior to obtaining second input data corresponding to one or more second portions of the utterance.

12. The system of claim 8, the one or more processors further to:
generate, using one or more Automatic Speech Recognition (ASR) components to process audio data representing the utterance, first text data corresponding to a plurality of predicted prefixes of the utterance; and
apply, as the input data to the one or more language models, at least a portion of the first text data corresponding to a first predicted prefix of the plurality of predicted prefixes.

13. The system of claim 8, the one or more processors further to:
generate, using one or more second language models and based at least on the input data, the plurality of predicted versions of the utterance,
wherein the one or more language models are associated with a first temperature and the one or more second language models are associated with a second temperature.

14. The system of claim 8, the one or more processors further to:
generate, using the one or more language models and based at least on the input data, the plurality of predicted versions of the utterance; and
update a temperature of the one or more language models subsequent to the generation of the plurality of predicted versions of the utterance and prior to the generation of the plurality of candidate responses.

15. The system of claim 8, the one or more processors further to:
apply, to a Text-to-Speech (TTS) component, first text data corresponding to a first portion of the specific candidate response prior to obtaining second text data corresponding to a second portion of the specific candidate response; and
generate, using the TTS component to process the first text data and the second text data, the output data.

16. The system of claim 8, wherein:
the portion of the utterance corresponds to a first predicted prefix of the utterance, and
the plurality of predicted versions of the utterance include at least one of the first predicted prefix or one or more second predicted prefixes of the utterance.

17. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

18. One or more processors comprising:
processing circuitry to cause presentation of a response to an utterance, the response generated based at least on using one or more language models to process first data representative of one or more predicted prefixes of the utterance prior to obtaining second data representative of at least one of one or more predicted remaining portions of the utterance or an actual version of the utterance.

19. The one or more processors of claim 18, the processing circuitry further to:
generate, using the one or more language models, one or more first tokens corresponding to a predicted version of the utterance;
update a temperature of the one or more language models subsequent to the generation of the one or more first tokens; and
generate, using the one or more language models and subsequent to updating the temperature, one or more second tokens corresponding to the response.

20. The one or more processors of claim 18, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
